(19) United States
(12) Patent Application Publication
(10) Pub. No.: US 2022/0366646 A1
(43) Pub. Date: Nov. 17, 2022

(54) Computer Vision Systems and Methods for Determining Structure Features from Point Cloud Data Using Neural Networks

(71) Applicant: Insurance Services Office, Inc., Jersey City, NJ (US)

(72) Inventors: Miguel Lopez Gavilan, Madrid (ES); Ryan Mark Justus, Lehi, UT (US); Bryce Zachary Porter, Lehi, UT (US); Francisco Rivas, Madrid (ES)

(73) Assignee: Insurance Services Office, Inc., Jersey City, NJ (US)

(21) Appl. No.: 17/746,506

(22) Filed: May 17, 2022

Related U.S. Application Data
(60) Provisional application No. 63/189,371, filed on May 17, 2021.

(51) Int. Cl. G06T 17/05; G06V 10/42; G06V 10/82; G06V 20/10; G06F 16/587; G06T 3/40

(52) U.S. Cl. CPC G06T 17/05; G06V 10/421; G06V 10/82; G06V 20/176; G06F 16/587; G06T 3/4053

(57) ABSTRACT

Computer vision systems and methods for determining structure features from point cloud data using neural networks are provided. The system obtains point cloud data of a structure or a property parcel having a structure present therein from a database. The system can preprocess the obtained point cloud data to generate another point cloud or 3D representation derived from the point cloud data by spatial cropping and/or transformation, down sampling, up sampling, and filtering. The system can also preprocess point features to generate and/or obtain any new features thereof. Then, the system extracts a structure and/or feature of the structure from the point cloud data utilizing one or more neural networks. The system determines at least one attribute of the extracted structure and/or feature of the structure utilizing the one or more neural networks.

### RELATED APPLICATIONS

The present application claims the benefit of priority of U.S. Provisional Application Ser. No. 63/189,371 filed on May 17, 2021, the entire disclosure of which is expressly incorporated herein by reference.

### BACKGROUND

### Technical Field

The present disclosure relates generally to the field of computer modeling of structures. More particularly, the present disclosure relates to computer vision systems and methods for determining structure features from point cloud data using neural networks.

### RELATED ART

Accurate and rapid identification and depiction of objects from digital imagery (e.g., aerial images, satellite images, LiDAR, point clouds, three-dimensional (3D) images, etc.) is increasingly important for a variety of applications. For example, information related to various objects of structures (e.g., structure faces, roof structures, etc.) and/or objects proximate to the structures (e.g., trees, pools, decks, etc.) and the features thereof (e.g., doors, walls, slope, tree cover, dimensions, etc.) is often used by construction professionals to specify materials and associated costs for both newly-constructed structures, as well as for replacing and upgrading existing structures. Further, in the insurance industry, accurate information about the objects of and/or proximate to structures and the features of these objects can be used to determine the proper costs for insuring the structures. For example, a condition of a roof structure of a structure and whether the structure is proximate to a pool are valuable sources of information.

Various software systems have been implemented to process point cloud data to determine and extract objects of and/or proximate to structures and the features of these objects from the point cloud data. However, these systems can be computationally expensive, time intensive (e.g., manually extracting structure features from point cloud data), unfeasible for complex structures and the features thereof, and have drawbacks rendering the systems unreliable, such as noisy or incomplete point cloud data. Moreover, such systems can require manual inspection of the structures by humans to accurately determine structure features. For example, a roof structure often requires manual inspection to determine roof structure features including, but not limited to, damage, slope, vents, and skylights. As such, the ability to automatically determine and extract features of a roof structure, without first performing manual inspection of the surfaces and features of the roof structure, is a powerful tool.

Thus, what would be desirable is a system that leverages one or more neural networks to automatically and efficiently determine and extract structure features from point cloud data without requiring manual inspection of the structure. Accordingly, the computer vision systems and methods disclosed herein solve these and other needs.

### SUMMARY

The present disclosure relates to computer vision systems and methods for determining structure features from point cloud data using neural networks. The system obtains point cloud data of a structure or a property parcel having a structure present therein from a database. In particular, the system receives a geospatial region of interest (ROI), an address, or georeferenced coordinates specified by a user and obtains point cloud data associated with the geospatial ROI from the database. The system can preprocess the obtained point cloud data to generate another point cloud or 3D representation derived from the point cloud data by performing specific preprocessing steps including, but not limited to, spatial cropping and/or transformation, down sampling, up sampling, and filtering. The system can also preprocess point features to generate and/or obtain any new features thereof. Then, the system extracts a structure and/or feature of the structure from the point cloud data utilizing one or more neural networks. The system determines at least one attribute of the extracted structure and/or feature of the structure utilizing the one or more neural networks. The system can utilize one or more neural networks to perform tasks including, but not limited to, detection, classification, segmentation, regression, and optimization. The system can refine and/or transform the at least one attribute of the extracted structure and/or feature of the structure.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a flowchart illustrating overall processing steps carried out by the system of the present disclosure;

FIG. 3 is a flowchart illustrating step 52 of FIG. 2 in greater detail;

FIG. 4A is a diagram illustrating a point cloud having a structure present therein;

FIGS. 4B-D are diagrams illustrating respective attributes of an extracted roof structure of the structure present in the point cloud of FIG. 4A;

FIG. 5A is a diagram illustrating another point cloud having a structure present therein;

FIG. 5B is a diagram illustrating scene segmentation of the point cloud of FIG. 5A;

FIGS. 5C-D are diagrams illustrating respective attributes of an extracted roof structure of the structure present in the point cloud of FIG. 5A; and

FIG. 6 is a diagram illustrating another embodiment of the system of the present disclosure.

### DETAILED DESCRIPTION

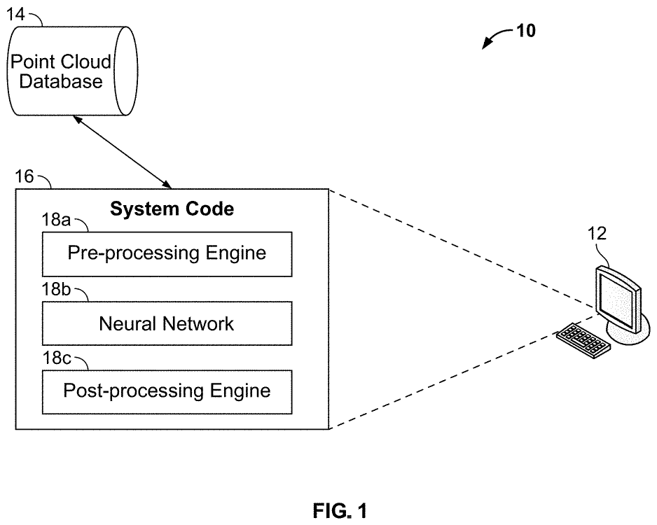

The present disclosure relates to systems and methods for determining property features from point cloud data using neural networks, as described in detail below in connection with FIGS. 1-6.

Turning to the drawings, FIG. 1 is a diagram illustrating an embodiment of the system 10 of the present disclosure. The system 10 could be embodied as a central processing unit 12 (processor) in communication with a database 14. The processor 12 could include, but is not limited to, a computer system, a server, a personal computer, a cloud computing device, a smart phone, or any other suitable device programmed to carry out the processes disclosed herein. The system 10 could retrieve point cloud data from the database 14 indicative of a structure or a property parcel having a structure present therein.

The database 14 could store one or more 3D representations of an imaged property parcel or location (including structures at the property parcel or location), such as point clouds, LiDAR files, etc., and the system 10 could retrieve such 3D representations from the database 14 and operate with these 3D representations. Alternatively, the database 14 could store digital images and/or digital image datasets including ground images, aerial images, satellite images, etc. where the digital images and/or digital image datasets could include, but are not limited to, images of residential and commercial buildings (e.g., structures). Additionally, the system 10 could generate one or more 3D representations of an imaged property parcel or location (including structures at the property parcel or location), such as point clouds, LiDAR files, etc. based on the digital images and/or digital image datasets. As such, by the terms “imagery” and “image” as used herein, it is meant not only 3D imagery and computer-generated imagery, including, but not limited to, LiDAR, point clouds, 3D images, etc., but also optical imagery (including aerial and satellite imagery).

The processor 12 executes system code 16 which utilizes one or more neural networks to determine and extract features of a structure and corresponding roof structure present therein from point cloud data obtained from the database 14. In particular, the system 10 can utilize one or more neural networks to process a point cloud representation of a property parcel having a structure present therein to perform tasks including, but not limited to, detection, classification, segmentation, regression, and optimization.

For example, the system 10 can perform object detection to estimate a location of an object of interest including, but not limited to, a structure wall face, a roof structure face, a segment, an edge and a vertex and/or estimate a wireframe or mesh model of the structure. The system 10 can perform point cloud classification to estimate probabilities that a point cloud belongs to a class or classes to determine if the point cloud includes a structure, determine if the structure is damaged, classify a type of the structure (e.g., residential or commercial) and classify objects of and/or proximate to the structure (e.g., a pool, a deck, a chimney, etc.). In another example, the system 10 can perform segmentation including tasks such as, but not limited to, semantic segmentation to estimate probabilities that each point belongs to a class and/or object (e.g., a tree, a pool, a structure wall face, a roof structure face, a chimney, a ground field, a segment, a segment type, and a vertex) and instance segmentation to estimate if a point belongs to a particular feature (e.g., an instance) of a structure or roof structure to differentiate points belonging to different structures or roof structure faces. The system 10 can also perform regression tasks to estimate values of each point (e.g., a 3D normal vector value, a curvature value, etc.) or estimate roof structure features (e.g., area, dimensions, slopes, condition, heights, edge lengths by type, etc.). In another example, the system 10 can perform optimization tasks to improve a point cloud including, but not limited to, increasing a density or resolution of the point cloud, providing missing point cloud data that is not visible in the point cloud, and filtering noise. The outputs generated by the neural network(s) can be used to characterize the property parcel and the structure present therein and/or can be refined and/or transformed by the system 10 or another system to obtain additional features of the property parcel and the structure present therein.

The system code 16 (non-transitory, computer-readable instructions) is stored on a computer-readable medium and executable by the hardware processor 12 or one or more computer systems. The code 16 could include various custom-written software modules that carry out the steps/processes discussed herein, and could include, but is not limited to, a pre-processing engine 18a, a neural network 18b and a post-processing engine 18c. The code 16 could be programmed using any suitable programming languages including, but not limited to, C, C++, C#, Java, Python or any other suitable language. Additionally, the code 16 could be distributed across multiple computer systems in communication with each other over a communications network, and/or stored and executed on a cloud computing platform and remotely accessed by a computer system in communication with the cloud platform. The code 16 could communicate with the database 14 which could be stored on the same computer system as the code 16, or on one or more other computer systems in communication with the code 16.

Still further, the system 10 could be embodied as a customized hardware component such as a field-programmable gate array (“FPGA”), application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

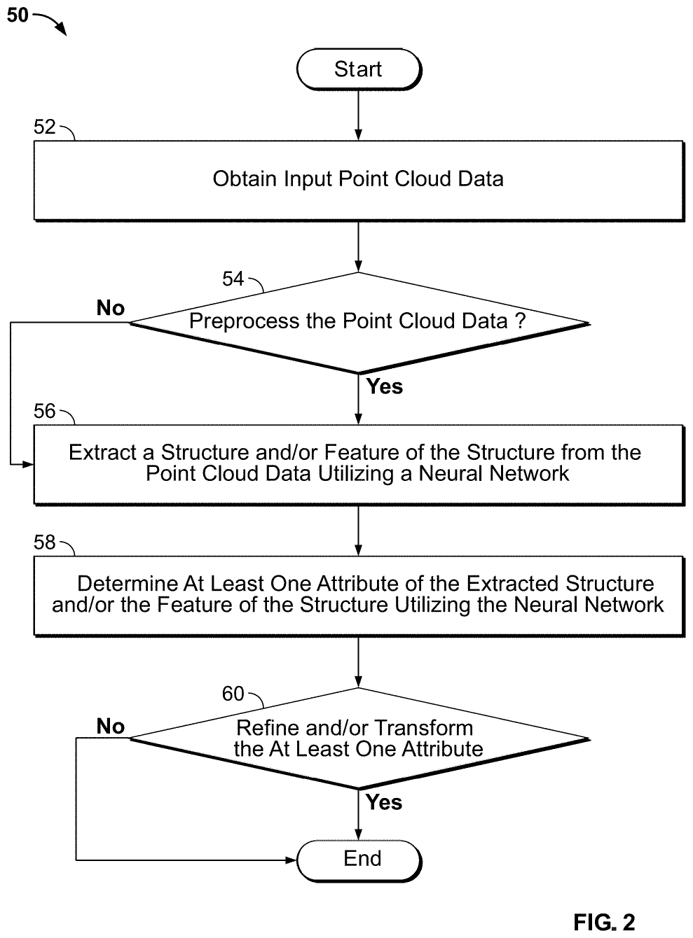

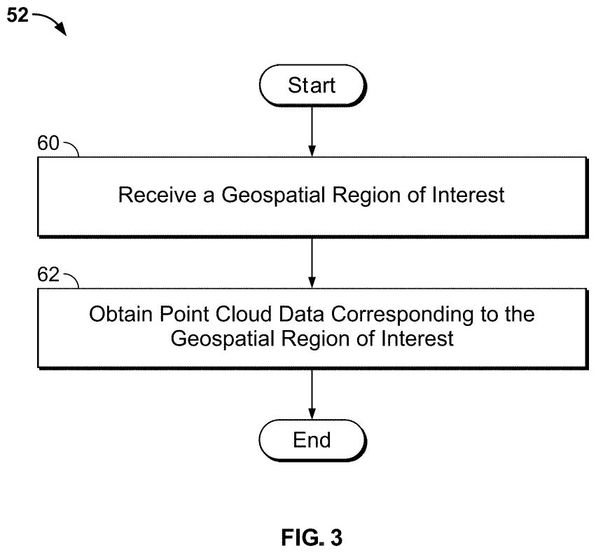

FIG. 2 is a flowchart illustrating overall processing steps 50 carried out by the system 10 of the present disclosure. Beginning in step 52, the system 10 obtains point cloud data of a structure or a property parcel having a structure present therein from the database 14. FIG. 3 is a flowchart illustrating step 52 of FIG. 2 in greater detail. Beginning in step 60, the system 10 receives a geospatial region of interest (ROI) specified by a user. For example, a user can input latitude and longitude coordinates of an ROI. Alternatively, a user can input an address of a desired property parcel or structure, georeferenced coordinates, and/or a world point of an ROI. The geospatial ROI can be represented by a generic polygon enclosing a geocoding point indicative of the address or the world point. The region can be of interest to the user because of one or more structures present in the region. A property parcel included within the ROI can be selected based on the geocoding point. As discussed in further detail below, a neural network can be applied over the area of the parcel to detect a structure or a plurality of structures situated thereon.

The geospatial ROI can also be represented as a polygon bounded by latitude and longitude coordinates. In a first example, the bound can be a rectangle or any other shape centered on a postal address. In a second example, the bound can be determined from survey data of property parcel boundaries. In a third example, the bound can be determined from a selection of the user (e.g., in a geospatial mapping interface). Those skilled in the art would understand that other methods can be used to determine the bound of the polygon. The ROI may be represented in any computer format, such as, for example, well-known text (“WKT”) data, TeX data, HTML, data, XML data, etc. For example, a WKT polygon can comprise one or more computed independent world areas based on the detected structure in the parcel.

In step 62, after the user inputs the geospatial ROI, the system 10 obtains point cloud data of a structure or a property parcel having a structure present therein corresponding to the geospatial ROI from the database 14. As mentioned above, the system 10 could retrieve 3D representations of an imaged property parcel or location (including structures at the property parcel or location), such as point clouds, LiDAR files, etc. from the database 14 and operate with these 3D representations. Alternatively, the system 10 could retrieve digital images and/or digital image datasets including ground images, aerial images, satellite images, etc. from the database 14 where the digital images and/or digital image datasets could include, but are not limited to, images of residential and commercial buildings (e.g., structures). Those skilled in the art would understand that any type of image can be captured by any type of image capture source. For example, the aerial images can be captured by image capture sources including, but not limited to, a plane, a helicopter, a paraglider, a satellite, or an unmanned aerial vehicle (UAV). The system 10 could generate one or more 3D representations of an imaged property parcel or location (including structures at the property parcel or location), such as point clouds, LiDAR files, etc. based on the digital images and/or digital image datasets.

Returning to FIG. 2, in step 54 the system 10 determines whether to preprocess the obtained point cloud data. If the system 10 determines to preprocess the point cloud data, then the system 10 utilizes a main neural network, one or more additional neural networks or any other suitable method to perform specific preprocessing steps to generate another point cloud or 3D representation derived from the point cloud data. For example, the system 10 can perform specific preprocessing steps including, but not limited to, one or more of: spatially cropping the point cloud based on a two-dimensional (2D) or 3D ROI; spatially transforming (e.g., rotating, translating, scaling, etc.) the point cloud; down sampling the point cloud to reduce a number of points, obtain a simplified point set representing the same ROI, and/or remove redundant points; up sampling the point cloud to increase a number of points, point density, and/or resolution, or fill empty regions; filtering the point cloud to remove outlier points and/or reduce noise; projecting the point cloud onto an image to obtain a 2D representation; and/or obtaining a voxel grid representation. In addition, the system 10 can preprocess point features to generate and/or obtain any new features thereof (e.g., spatial coordinates or normalized color values). It should be understood that the system 10 can perform one or more of the aforementioned preprocessing steps in any particular order. Alternatively, if the system 10 determines not to preprocess the point cloud data, then the process proceeds to step 56.

In step 56, the system 10 extracts a structure and/or feature of the structure from the point cloud data utilizing one or more neural networks. For example, the system 10 can utilize one or more neural networks including, but not limited to, a 3D convolutional neural network (CNN) applicable to a voxelized point cloud representation (e.g., sparse or dense); a PointNet-like network or graph based network (e.g., a dynamic graph CNN) applicable directly to points, or a 2D CNN applicable to a 2D projection of the point cloud data. It should be understood that the system 10 can extract features for each point of the point cloud data and/or for an entirety of the point cloud (e.g., a point set) by utilizing the one or more neural networks. Additionally, the system 10 can optimize parameters of a neural network for performing a target task by utilizing, among other data points, a high quality 3D structure model or a point cloud labeled via a structure model, an image, a 2D projection, or human intervention (e.g., directly or indirectly utilizing previously labeled images).

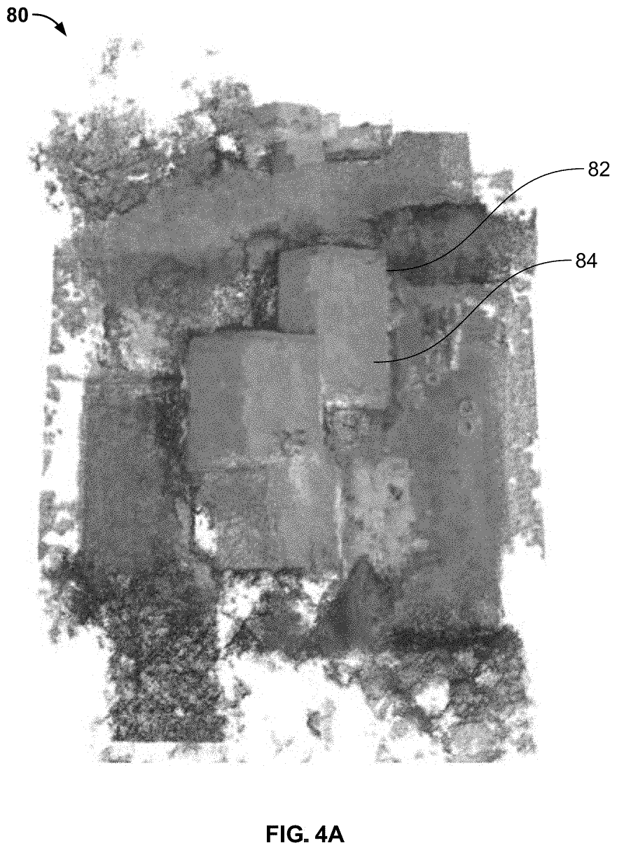

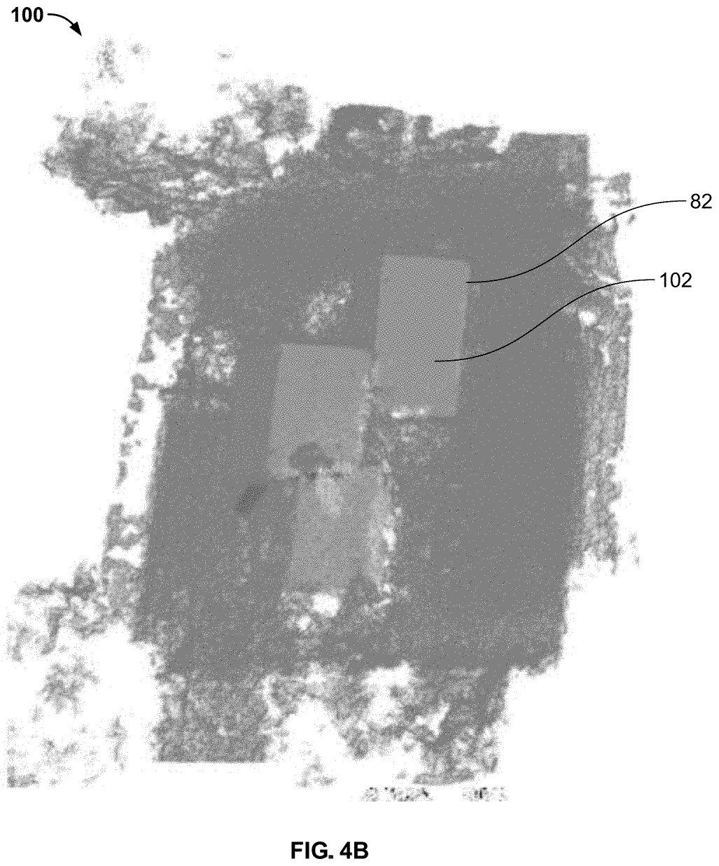

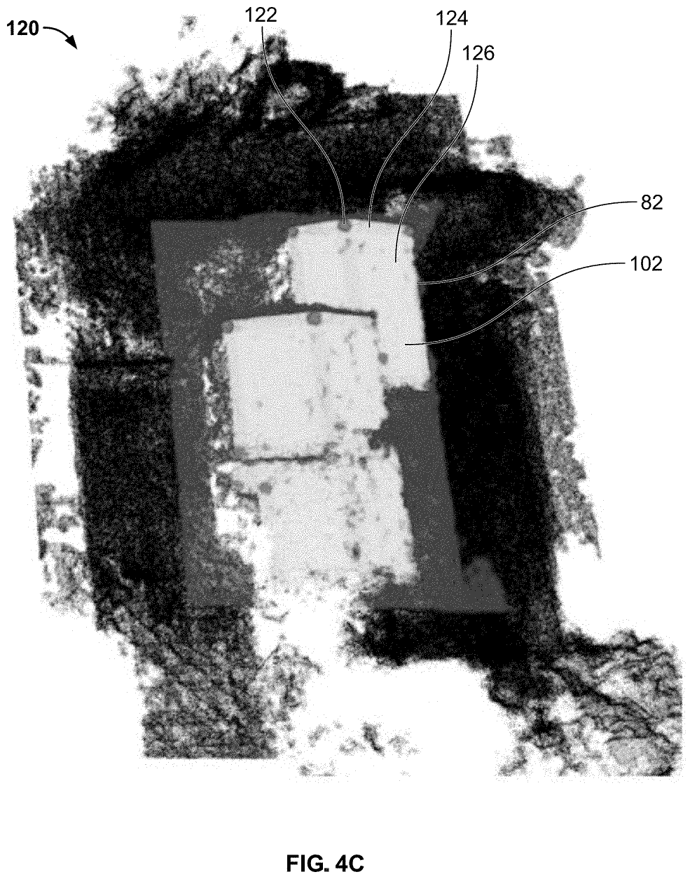

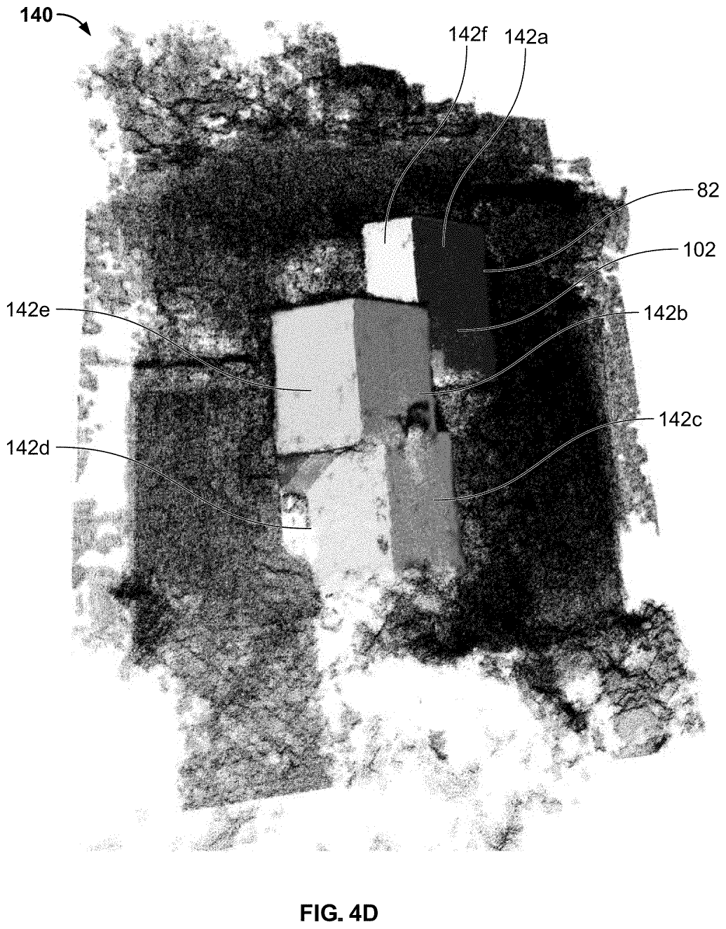

In step 58, the system 10 determines at least one attribute of the extracted structure and/or feature of the structure utilizing the one or more neural networks. The system 10 can utilize one or more neural networks to perform tasks including, but not limited to, detection, classification, segmentation, regression, and optimization as described in more detail below and as illustrated in connection with FIGS. 4A-D and 5A-D. It should be understood that the system 10 can utilize any neural network suitable for performing the foregoing tasks.

The system 10 can perform object detection to estimate a location of a structure and the objects thereof (e.g., a structure wall face, vertex, or edge) and a bounding box enclosing the structure and/or different building-related structures (e.g., a roof structure) and the objects thereof (e.g., a roof structure face, segment, vertex, or edge). The system 10 can also perform point cloud classification to estimate probabilities that a point cloud belongs to a class or classes. The class can be obtained from the estimated probability values by utilizing an argmax operation or by applying probability thresholds. It should be understood that point cloud classification tasks can include, but are not limited to, determining if the point cloud includes a structure and, if so, classifying a type of the structure (e.g., residential or commercial), determining if the structure is damaged and, if so, classifying a type and severity of the damage to the structure, and classifying objects of and/or proximate to the structure (e.g., a chimney, rain gutters, a skylight, a pool, a deck, a tree, a playground, etc.).

The system 10 can perform segmentation to estimate probabilities that each point belongs to a class and/or object instance. The class can be obtained from the estimated probability values by utilizing an argmax operation or by applying probability thresholds. It should be understood that segmentation tasks can include, but are not limited to, scene object segmentation to determine if a point belongs to a structure wall, a roof structure, the ground (e.g., ground field segmentation to determine a roof structure relative height), a property parcel object (e.g., tree segmentation to estimate tree coverage and proximity), and road segmentation; roof segmentation to determine if a point belongs to a roof structure face, edge or vertex, a type of the roof structure edge or vertex (e.g., an eave, a rake, a ridge, a valley, a hip, etc.), and if a point belongs to a roof structure object (e.g., a chimney, a solar panel, etc.); roof face segmentation to extract and differentiate roof structure faces; and roof instance segmentation to segment different roof structure types (e.g., gable, flat, barrel-vaulted, etc.) of a roof structure.

The system 10 can perform regression tasks to estimate values of each point (e.g., a 3D normal vector value, a curvature value, etc.) or estimate roof structure features (e.g., area, dimensions, slopes, condition, heights, edge lengths by type, etc.). The system 10 can also perform optimization tasks to improve a point cloud including, but not limited to, increasing a density or resolution of the point cloud by estimating additional points, providing missing point cloud data that is not visible in the point cloud, and filtering noise.

In step 60, the system 10 determines whether to refine and/or transform the at least one attribute of the extracted structure and/or the feature of the structure. If the system 10 determines to refine and/or transform the at least one attribute of the extracted structure and/or feature of the structure, then the system 10 refines and/or transforms the at least one attribute to obtain additional features of interest and/or characterize the property parcel and/or structure present therein. Alternatively, if the system 10 determines not to refine and/or transform the at least one attribute of the extracted structure and/or feature of the structure, then the process ends.

FIG. 4A is a diagram illustrating a point cloud 80 having a structure 82 and corresponding roof structure 84 present therein and FIGS. 4B-D are diagrams illustrating respective attributes of an extracted roof structure 102 of the structure 82 present in the point cloud 80 of FIG. 4A. In particular, FIG. 4B is a diagram 100 illustrating point normal vector estimation encoded as color of the roof structure 102, FIG. 4C is a diagram 120 illustrating roof segmentation of the roof structure 102 including points corresponding to vertices 122, edges 124 and faces 126 of the roof structure 102, and FIG. 4D is a diagram 140 illustrating roof face segmentation of the roof structure 102 including a plurality of roof structure faces 142a-f differentiated by color. The diagrams of FIGS. 4B-4D are generated from the point cloud of FIG. 4A using the processed steps discussed herein in connection with FIGS. 2-3.

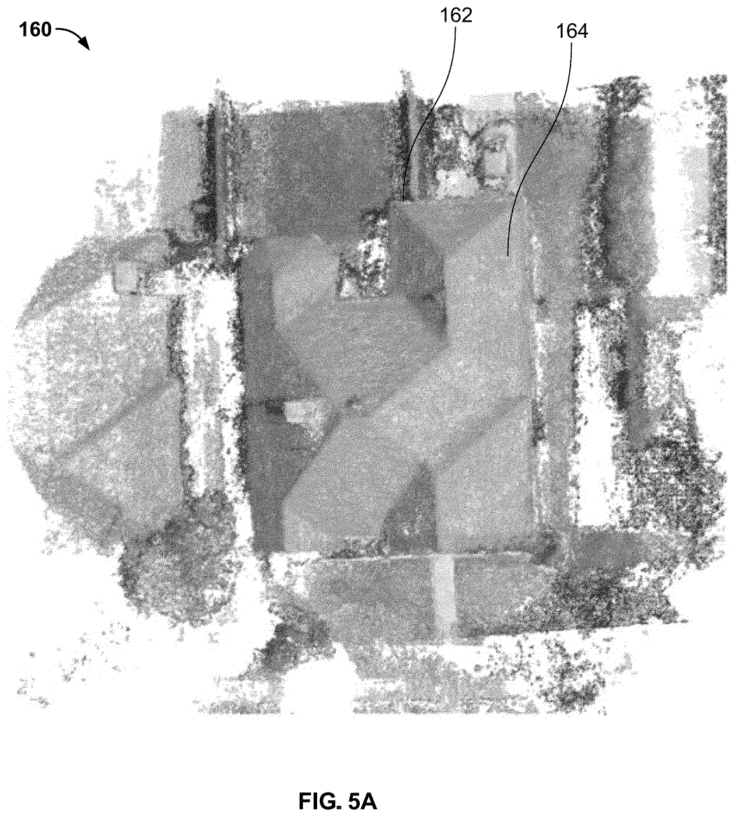

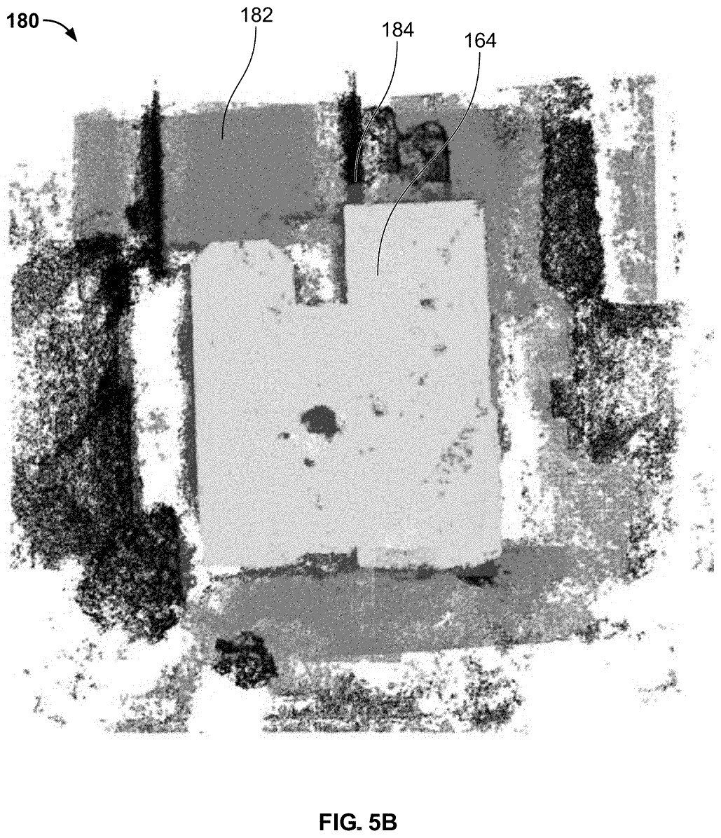

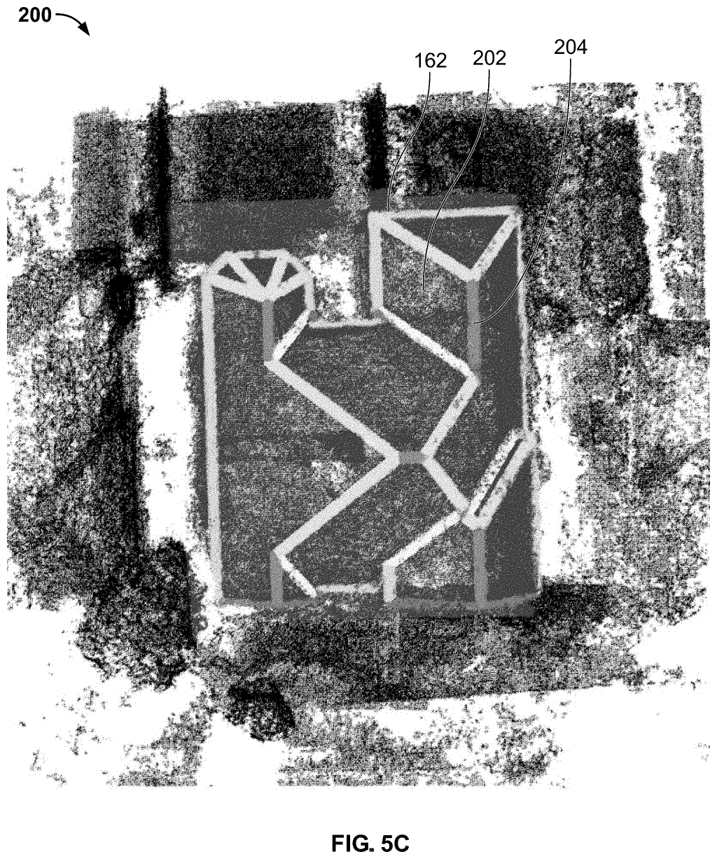

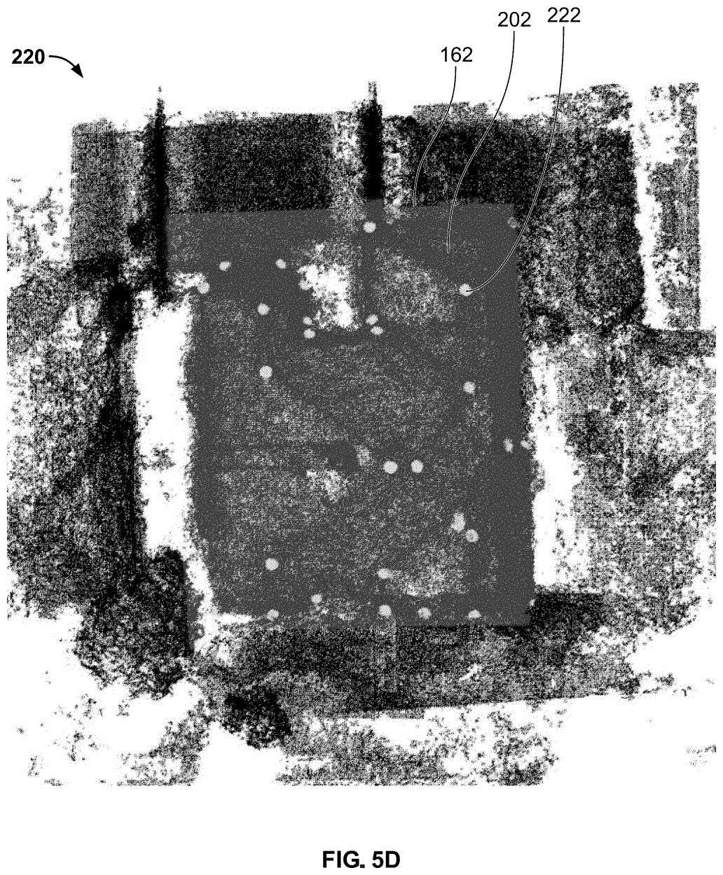

FIG. 5A is a diagram illustrating a point cloud 160 having a structure 162 and corresponding roof structure 164 present therein and FIG. 5B is a diagram 180 illustrating scene segmentation of the point cloud 160 of FIG. 5A. As shown in FIG. 5B, the point cloud 160 is segmented into points indicative of a background 182, a ground field 184 and the roof structure 164 of the point cloud 160. FIGS. 5C-D are diagrams illustrating respective attributes of an extracted roof structure 202 of the structure 162 present in the point cloud 160 of FIG. 5A. In particular, FIG. 5C is a diagram 200 illustrating edge type segmentation of the roof structure 202 including a plurality of edges 204 of the roof structure 202, and FIG. 5D is a diagram 220 illustrating roof face segmentation of the roof structure 202 including a plurality of vertices 222. The diagrams of FIGS. 5B-4D are generated from the point cloud of FIG. 5A using the processed steps discussed herein in connection with FIGS. 2-3.

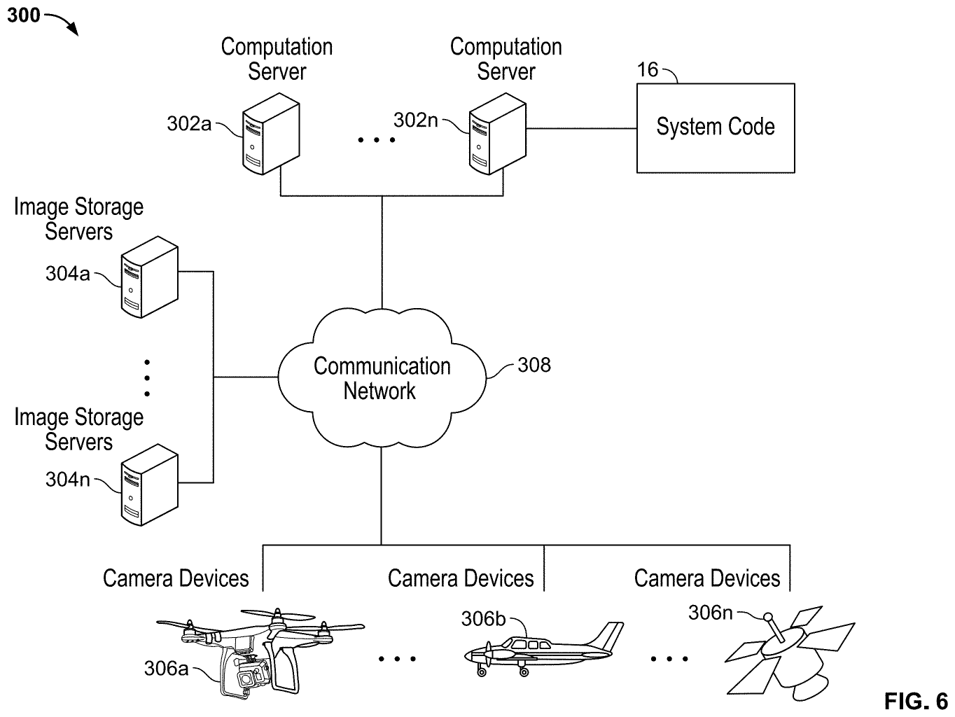

FIG. 6 a diagram illustrating another embodiment of the system 300 of the present disclosure. In particular, FIG. 6 illustrates additional computer hardware and network components on which the system 300 could be implemented. The system 300 can include a plurality of computation servers 302a-302n having at least one processor and memory for executing the computer instructions and methods described above (which could be embodied as system code 16). The system 300 can also include a plurality of image storage servers 304a-304n for receiving imagery data and/or video data. The system 300 can also include a plurality of camera devices 306a-306n for capturing imagery data and/or video data. For example, the camera devices can include, but are not limited to, an unmanned aerial vehicle 306a, an airplane 306b, and a satellite 306n. The computation servers 302a-302n, the image storage servers 304a-304n, and the camera devices 306a-306n can communicate over a communication network 308. Of course, the system 300 need not be implemented on multiple devices, and indeed, the system 300 could be implemented on a single computer system (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A computer vision system for determining features of a structure from point cloud data, comprising:
a database storing point cloud data; and
a processor in communication with the database, the processor programmed to perform the steps of:
retrieving the point cloud data from the database;
processing the point cloud data using a neural network to extract a structure or a feature of a structure from the point cloud data; and
determining at least one attribute of the extracted structure or the feature of the structure using the neural network.

2. The computer vision system of claim 1, wherein the database stores one or more of LiDAR data, a digital image, a digital image dataset, a ground image, an aerial image, a satellite image, an image of a residential building, or an image of a commercial building.

3. The computer vision system of claim 2, wherein the processor generates one or more three-dimensional representations of the structure or the feature of the structure based on the digital image or the digital image dataset.

4. The computer vision system of claim 1, wherein the structure or the feature of the structure comprises one or more of a structure wall face, a roof structure face, a segment, an edge, a vertex, a wireframe model, or a mesh model.

5. The computer vision system of claim 1, wherein the processor estimates probabilities that the point cloud data belongs to one or more classes to determine if the point cloud data includes the structure, to determine if the structure is damaged, to classify a type of the structure, or to classify one or more objects associated with the structure.

6. The computer vision system of claim 1, wherein the processor performs semantic segmentation to estimate a probability that a point of the point could data belongs to a class or an object.

7. The computer vision system of claim 1, wherein the processor performs instance segmentation to estimate if a point of the point could data belongs to a feature of a structure.

8. The computer vision system of claim 1, wherein the processor performs a regression task to estimate values of each point of the point cloud data or to estimate roof structure features from the point cloud data.

9. The computer vision system of claim 1, wherein the processor performs an optimization task to improve the point cloud data.

10. The computer vision system of claim 9, wherein processor improves the point cloud data by increasing a density or resolution of the point cloud data, providing missing point cloud data, and filtering noise.

11. The computer vision system of claim 1, wherein the step of retrieving the point cloud data from the database comprises receiving a geospatial region of interest (ROI) specified by a user.

12. The computer vision system of claim 11, wherein the processor obtains point cloud data of a structure or a property parcel corresponding to the geospatial ROI.

13. The computer vision system of claim 1, wherein the processor preprocesses the point cloud data by performing one or more of: spatially cropping the point cloud data, spatially transforming the point cloud data, down sampling the point cloud data, removing redundant points from the point could data, up sampling the point cloud data, filtering the point cloud data, projecting the point cloud data onto an image to obtain a two-dimensional representation, obtaining a voxel grid representation, or generating a new feature from the point cloud data.

14. A computer vision method for determining features of a structure from point cloud data, comprising the steps of:
retrieving by a processor point cloud data stored in the database;
processing the point cloud data using a neural network to extract a structure or a feature of a structure from the point cloud data; and
determining at least one attribute of the extracted structure or the feature of the structure using the neural network.

15. The computer vision method of claim 14, wherein the database stores one or more of LiDAR data, a digital image, a digital image dataset, a ground image, an aerial image, a satellite image, an image of a residential building, or an image of a commercial building.

16. The computer vision method of claim 15, further comprising generating one or more three-dimensional representations of the structure or the feature of the structure based on the digital image or the digital image dataset.

17. The computer vision method of claim 14, wherein the structure or the feature of the structure comprises one or more of a structure wall face, a roof structure face, a segment, an edge, a vertex, a wireframe model, or a mesh model.

18. The computer vision method of claim 14, further comprising estimating probabilities that the point cloud data belongs to one or more classes to determine if the point cloud data includes the structure, to determine if the structure is damaged, to classify a type of the structure, or to classify one or more objects associated with the structure.

19. The computer vision method of claim 14, further comprising performing semantic segmentation to estimate a probability that a point of the point could data belongs to a class or an object.

20. The computer vision method of claim 14, further comprising performing instance segmentation to estimate if a point of the point could data belongs to a feature of a structure.

21. The computer vision method of claim 14, further comprising performing a regression task to estimate values of each point of the point cloud data or to estimate roof structure features from the point cloud data.

22. The computer vision method of claim 14, further comprising performing an optimization task to improve the point cloud data.

23. The computer vision method of claim 22, further comprising improving the point cloud data by increasing a density or resolution of the point cloud data, providing missing point cloud data, and filtering noise.

24. The computer vision method of claim 14, wherein the step of retrieving the point cloud data from the database comprises receiving a geospatial region of interest (ROI) specified by a user.

25. The computer vision method of claim 24, further comprising obtaining point cloud data of a structure or a property parcel corresponding to the geospatial ROI.

26. The computer vision method of claim 14, further comprising preprocessing the point cloud data by performing one or more of: spatially cropping the point cloud data, spatially transforming the point cloud data, down sampling the point cloud data, removing redundant points from the point could data, up sampling the point cloud data, filtering the point cloud data, projecting the point cloud data onto an image to obtain a two-dimensional representation, obtaining a voxel grid representation, or generating a new feature from the point cloud data.
